(19) United States
(12) Patent Application Publication
(10) Pub. No.: US 2024/0217395 A1
(43) Pub. Date: Jul. 4, 2024

(54) ELEVATED PASSENGER SEATS FOR VEHICLES

(71) Applicant: Victor Manuel Chavez Vazquez, San Antonio, TX (US)

(72) Inventor: Victor Manuel Chavez Vazquez, San Antonio, TX (US)

(21) Appl. No.: 18/219,653

(22) Filed: Jul. 8, 2023

Related U.S. Application Data
(60) Provisional application No. 63/436,121, filed on Dec. 30, 2022.

(51) Int. Cl. B60N 2/01; B60N 3/06; B60R 7/04

(52) U.S. Cl. CPC B60N 2/01; B60N 3/063; B60R 7/043

(57) ABSTRACT

An elevated seat structure for a row of rear passengers in a vehicle, the elevated seat structure includes a rigid support structure designed to be fastened to a floor of a vehicle and a passenger seat assembly to be attached to the top of the rigid support structure. A height of the rigid support structure is predetermined to provide an elevated rear passenger seat that is elevated relative to a passenger seat located in front of a row of rear passengers, the elevated rear passenger seat thereby providing a rear passenger a forward view through a front windshield of the vehicle that is elevated relative to a passenger sitting in front of the rear passenger.

### CROSS-REFERENCE TO RELATED APPLICATIONS

This application claims the benefit of, and priority to, U.S. Provisional Patent Application No. 63/436,121 titled “ELEVATED PASSENGER SEATS FOR VEHICLES” filed on Dec. 30, 2022. That application is incorporated by reference in its entirety herein.

### BACKGROUND

### Field of Art

The present invention relates generally to passenger vehicle seating, and more specifically to an elevated seat structure that enhances forward visibility for passengers seated in the back of a vehicle and provides additional storage capacity.

### Background

In conventional passenger vehicles, passengers situated in the back seats typically have a limited view of the road ahead. This limited visibility is primarily due to the linear arrangement of the seats, with the rear seats directly behind the front seats. As a result, rear passengers often need to maneuver their heads awkwardly to look around the front seat passenger or driver to get a better view of the road ahead.

This inconvenience can negatively impact the travel experience for passengers who wish to observe the surrounding landscape or monitor the vehicle's progress. Moreover, this issue extends beyond mere inconvenience in certain applications. For instance, in military or security vehicles, the lack of forward visibility for rear passengers could potentially pose a significant risk.

Without an unobstructed view of what's ahead, rear passengers may be unable to promptly identify and respond to evolving dangerous scenarios in front of the vehicle. In some circumstances, passengers may become car sick due to the movement of the vehicle without a clear forward view. Currently, the riding experience for passengers in rear seats is very poor.

### SUMMARY

The present invention provides an innovative solution to the problem of limited forward viewing by rear-seated passengers. This is achieved by introducing an elevated seat structure for rear passengers, allowing them to look forward over the heads of front-row passengers.

In particular, the invention comprises a rigid support structure to be fastened to the vehicle floor, and a passenger seat assembly to be attached on top of the support structure. The height of the support structure is predetermined such that the resulting elevated rear passenger seat provides a significantly enhanced forward view.

In certain embodiments, the elevated rear passenger seat structure provides usable stowage space beneath the seats, thereby adding extra functionality while maintaining the advantage of improved visibility. Depending on configuration details of the vehicle, the stowage space could be accessible from the front, sides, and/or back of the stowage space, and the volume of the additional stowage space is dependent upon the height of the rigid support structure that provides the elevation of the passenger seat assembly.

Further enhancements include an adjustable footrest(s), which assists rear passengers in comfortably positioning themselves onto the elevated seat, and can be adjusted for optimal comfort at the elevated seating height.

The invention is versatile and can be adapted for use in vehicles with multiple rows of rear passenger seats, such as those found in minivans or large SUVs. This makes it applicable to a wide range of vehicle models, including but not limited to passenger automobiles and pickups.

In addition to newly manufactured vehicles designed with the concepts of the present invention, it also encompasses retrofit kits comprising seat components. These kits can be utilized to replace existing seats in conventional vehicles with one or more rows of rear passenger seats, thereby providing enhanced forward viewing for a broad spectrum of vehicle types and models.

In summary, the present invention improves the seating arrangements in vehicles by elevating rear passenger seats, greatly enhancing forward visibility and adding additional functionalities for added convenience and comfort.

### BRIEF DESCRIPTION OF THE DRAWING FIGURES

The accompanying drawings illustrate several embodiments and, together with the description, serve to explain the principles of the invention according to the embodiments. It will be appreciated by one skilled in the art that the particular arrangements illustrated in the drawings are merely exemplary and are not to be considered as limiting of the scope of the invention or the claims herein in any way.

FIG. 1A illustrates a side view showing an exemplary concept of elevated passenger seats in the present invention in accordance with an embodiment of the invention.

FIG. 1B also illustrates a side view showing an exemplary concept of elevated passenger seats in the present invention in accordance with an embodiment of the invention.

FIG. 1C illustrates a side view of an exemplary vehicle with multiple rows of elevated passenger seats in the present invention in accordance with an embodiment of the invention.

FIG. 1D illustrates a side view of a different exemplary vehicle with raised seats of the present invention.

FIG. 2A illustrates an exemplary stowage compartment in a closed configuration in accordance with an embodiment of the invention.

FIG. 2B illustrates an exemplary stowage compartment in an open configuration in accordance with an embodiment of the invention.

FIG. 2C illustrates an exemplary stowage compartment in accordance with an embodiment of the invention.

FIG. 3A illustrates a front perspective view showing an exemplary concept of elevated passenger seats in the present invention in accordance with an embodiment of the invention.

FIG. 3B illustrates a back perspective view showing an exemplary concept of elevated passenger seats in the present invention in accordance with an embodiment of the invention.

FIG. 4 illustrates an exemplary embodiment of adjustable footrests in accordance with an embodiment of the invention.

FIG. 5A illustrates a side view showing an exemplary concept of elevated passenger seats in the present invention in accordance with an embodiment of the invention.

FIG. 5B illustrates a side view showing an exemplary concept of elevated passenger seats in a different vehicle in accordance with an embodiment of the invention.

### DETAILED DESCRIPTION OF EMBODIMENTS

The present invention provides interior passenger accommodation components that permit passengers in rear seats to be elevated for better forward viewing. A footrest can be provided for each elevated passenger seat such that the passenger can adjust the footrest as desired when seated in the elevated seat. In some preferred embodiments the elevated seat structure provides additional space that can be used for stowage.

The invention is described by reference to various elements herein. It should be noted, however, that although the various elements of the inventive apparatus are described separately below, the elements need not necessarily be separate. The various embodiments may be interconnected and may be cut out of a singular block or mold. The variety of different ways of forming an inventive apparatus, in accordance with the disclosure herein, may be varied without departing from the scope of the invention.

Generally, one or more different embodiments may be described in the present application. Further, for one or more of the embodiments described herein, various alternative arrangements may be described; it should be appreciated that these are presented for illustrative purposes only and are not limiting of the embodiments contained herein or the claims presented herein in any way. One or more of the arrangements may be widely applicable to numerous embodiments, as may be readily apparent from the disclosure. In general, arrangements are described in sufficient detail to enable those skilled in the art to practice one or more of the embodiments, and it should be appreciated that other arrangements may be utilized and that structural changes may be made without departing from the scope of the embodiments. Particular features of one or more of the embodiments described herein may be described with reference to one or more particular embodiments or figures that form a part of the present disclosure, and in which are shown, by way of illustration, specific arrangements of one or more of the aspects. It should be appreciated, however, that such features are not limited to usage in the one or more particular embodiments or figures with reference to which they are described. The present disclosure is neither a literal description of all arrangements of one or more of the embodiments nor a listing of features of one or more of the embodiments that must be present in all arrangements.

Headings of sections provided in this patent application and the title of this patent application are for convenience only and are not to be taken as limiting the disclosure in any way.

Devices and parts that are connected to each other need not be in continuous connection with each other, unless expressly specified otherwise. In addition, devices and parts that are connected with each other may be connected directly or indirectly through one or more connection means or intermediaries.

A description of an aspect with several components in connection with each other does not imply that all such components are required. To the contrary, a variety of optional components may be described to illustrate a wide variety of possible embodiments and in order to more fully illustrate one or more embodiments. Similarly, although process steps, method steps, or the like may be described in a sequential order, such processes and methods may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the embodiments, and does not imply that the illustrated process is preferred. Also, steps are generally described once per aspect, but this does not mean they must occur once, or that they may only occur once each time a process, or method is carried out or executed. Some steps may be omitted in some embodiments or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Alternate implementations are included within the scope of various embodiments in which, for example, functions may be executed out of order from that shown or discussed, including substantially concurrently or in reverse order, depending on the functionality involved, as would be understood by those having ordinary skill in the art.

The apparatus and structures of the present invention provide passenger accommodations that provide rear passengers elevated seats relative to the front seat occupants.

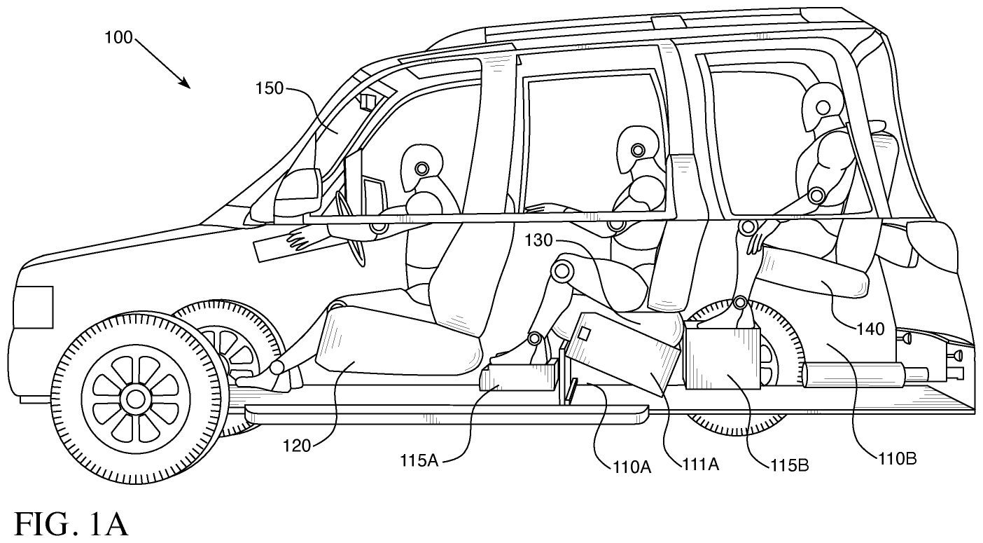

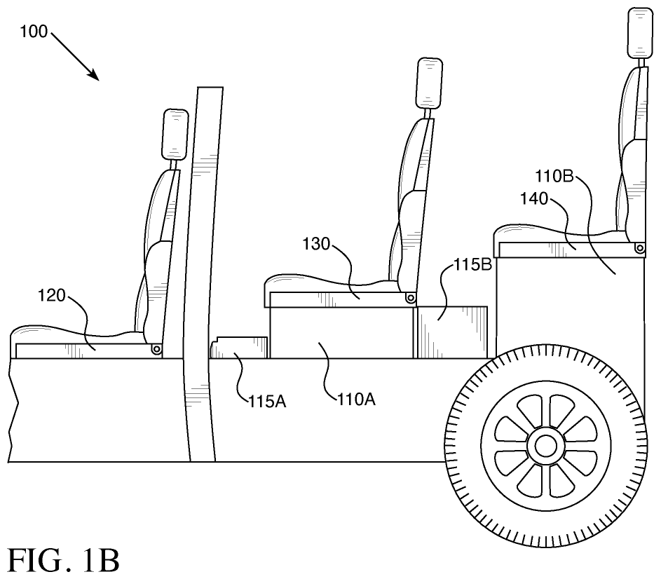

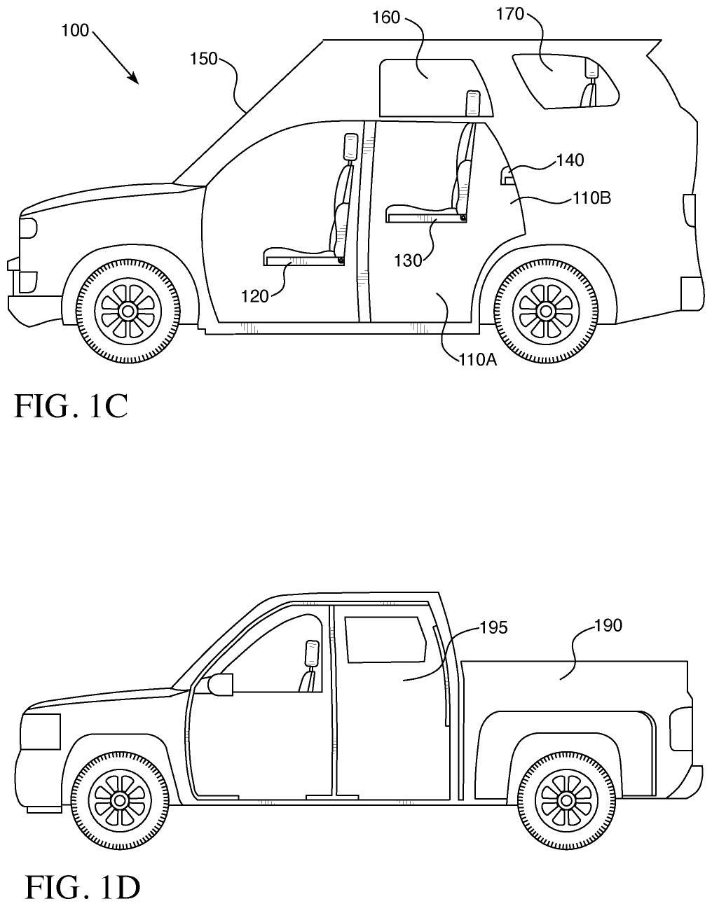

FIG. 1A and FIG. 1B illustrate exemplary concepts of the invention by illustrating how the rear passenger seats 130 and/or 140 are elevated relative to the front row of seats 120. FIGS. 1A and 1B illustrate a side view of a vehicle 100 in which rows of rear passenger seats 130, 140 are elevated relative to the front row of seats 120. Many modern passenger vehicles 100 have windshields 150 (illustrated in FIG. 1A) that extend to the roof of the vehicle, so that rear passengers seated in elevated seats 130 and/or 140 (if applicable) will be able to have a forward view through the windshield. In an exemplary embodiment, first rear seats 130 are raised approximately 22 cm relative to the front seat row 120, and second row of seats 140 are raised approximately 22 cm relative to the first rear seats 130. This elevation distance is exemplary only, but it is expected that the elevation difference for rear seat rows will be between 5 cm and 60 cm. It should also be clear that the stowage compartment height increases progressively as more rear seat rows are added since the height is cumulative, which means that the stowage space volume underlying each additional rear seat row likewise increases incrementally as more rows of rear seats are added to a vehicle.

As illustrated in FIG. 1C, an exemplary vehicle 100 of the present invention, include side windows 160 and/or 170 that provide side views for occupants of the two rows of passenger seats, and the vehicle roof has a height that accommodates the elevated rear seats, so it should be clear that the exemplary vehicle 100 has been designed with features that support the elevated rear seats. The side windows 160 and/or 170 not only provide viewing capability for the elevated passengers but also provide aesthetic and safety features to the vehicle 100. In this exemplary vehicle, the space 110A under the first row 130 of rear passenger seats could be used as additional stowage space if the rigid support structure has been designed to have access openings for permitting items to be inserted and removed. Similarly and not shown in FIG. 1C, the support structure of the second row 140 of rear seats could provide an even larger stowage compartment, which might be accessible via access openings in the front face of the rigid support structure or access openings in the back face of the support structure.

FIG. 1D shows a configuration of the vehicle 100 as including a tailgate or trunk extension 190 increases the overall volume by increasing the depth of the cargo bed. This improves the aesthetics with a raised back seat. In one embodiment, the cargo bed wall may include an access door (not illustrate) to access the stowage area under the seats that are directly in front of the cargo bed to enable further access to the vehicle trunk area as well as potentially providing access to the rear side of the stowage area under the second row of rear seats 140. In one embodiment of the invention, the rear window may also be raised 195 as illustrated.

In this exemplary embodiment of FIG. 1A there are two rows of rear passenger seats 130, 140, but it should be clear that the concept applies in vehicles having only one row of rear seats, and would even apply in vehicles with more than two rows of rear seats. Although the exemplary vehicle 100 has features suggesting that the vehicle 100 was designed/manufactured in consideration of the elevated rear seats, it should be clear that a number of conventional vehicle designs would support elevated seats post production, with little modifications except the removal of the production seat assemblies and installation of the elevated seat assemblies, thereby providing capability to install elevated seats via a retrofit kit of parts.

Thus, in some vehicle configurations, the existing seat assembly might be detached from the vehicle frame, to permit installation of a stowage compartment, to provide elevation, to which the removed seat assembly is then reattached to the top of the inserted stowage compartment. In other configurations the existing seat assemblies might have to be replaced by an elevated seat assembly including a support stowage compartment with a seat row already attached.

For example, a number of conventional van designs already incorporate higher roofs that would accommodate installation of elevated rear seats, and many sedan designs have roof heights adequate to accommodate having the single rear seat row as being elevated.

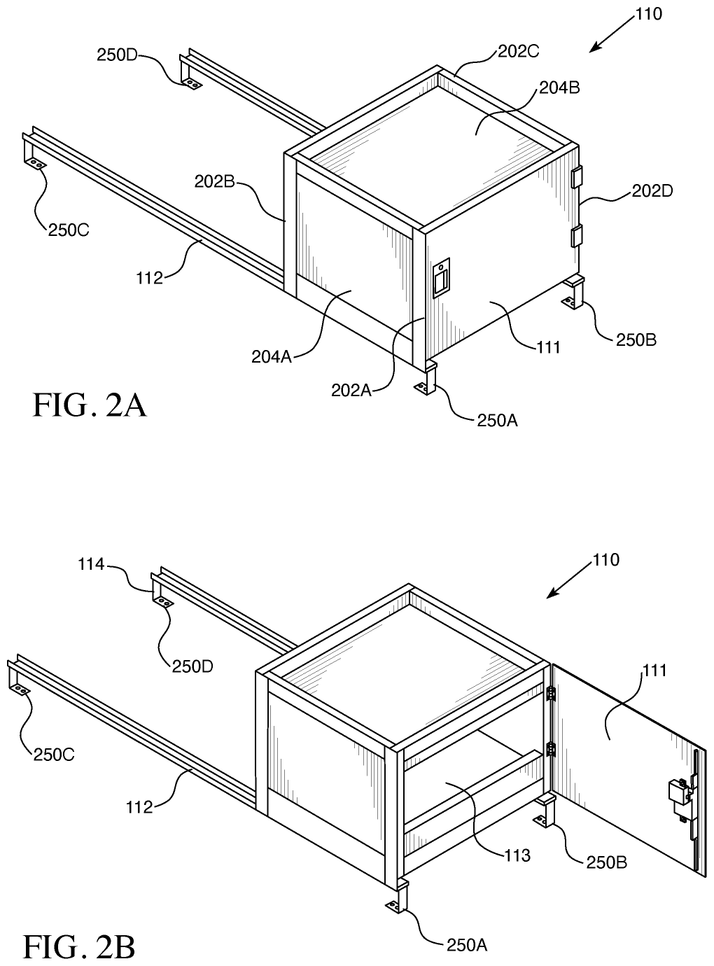

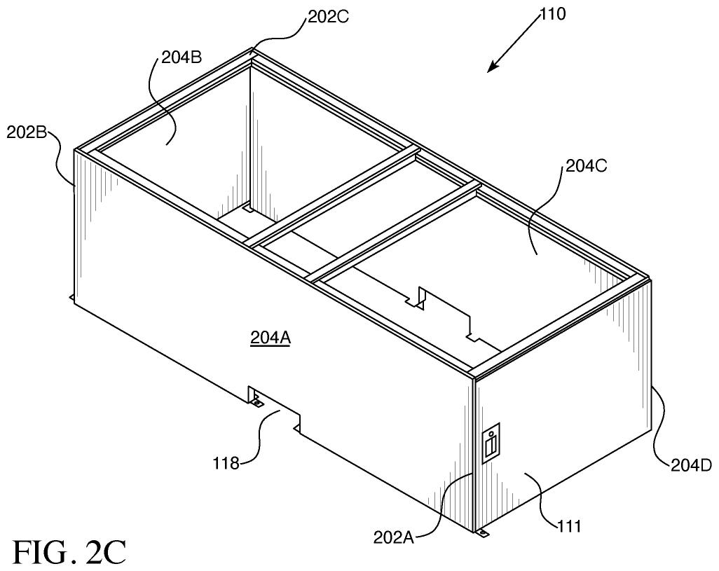

FIGS. 2A and 2B illustrate an exemplary rigid support structure 110. The rigid support structure 110 is conceptually illustrated as 110A and 110B in FIGS. 1A-1C. The rigid support structure 110 creates or encloses at least one stowage space 113. In one embodiment, the stowage may be accessed by an access port 111. The access port 111 may be a door that opens from a hinge, slides like a shutter or a garage, or may open and close via any mechanism that would be used or known by a person of ordinary skill in the art without departing from the scope of the invention. In one embodiment, the rigid support structure 110 is formed by support members 202A, 202B, 202C, and/or 202D as well as closure elements 204A and/or optionally 204B that may extend between the various support members 202A, 202B, 202C, and/or 202D. As described herein and illustrated in various figures, the rigid support structure 110 may be placed below a seat 130 and/or 140. Additionally, it may be placed over the floorboards of a vehicle to help raise the seat height 130 and/or 140.

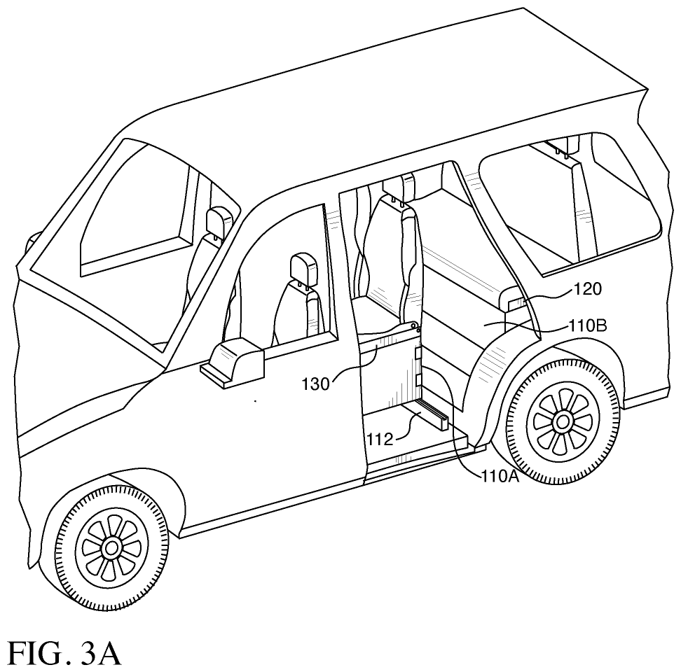

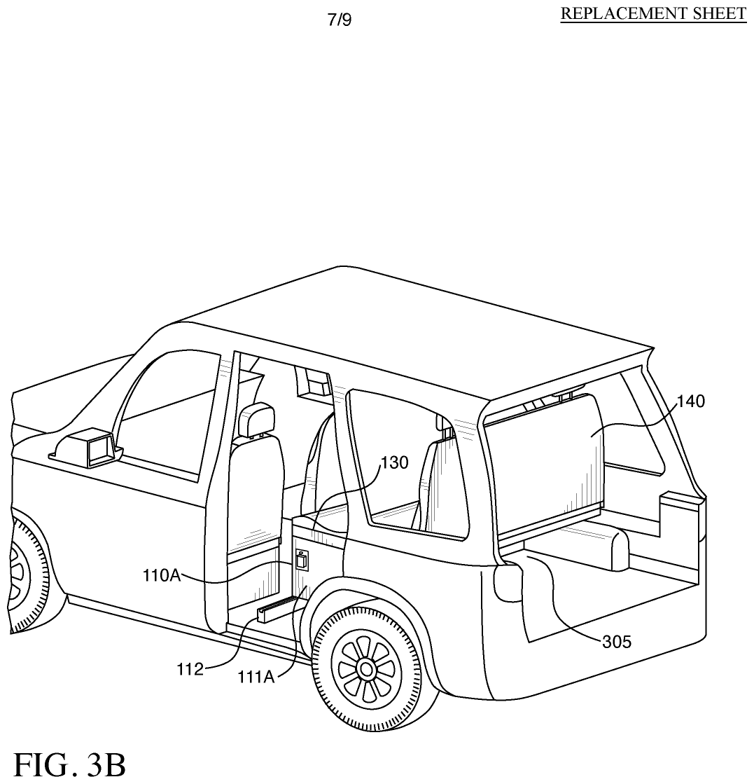

FIGS. 2A and 2B also illustrate a sliding mechanism 112. The sliding mechanism 112 enables the rigid support structure 110 to move across the sliding mechanism structure. In one embodiment, the sliding mechanism 112 may be laid out in one orientation extending from one door to the middle. In other embodiments, the sliding mechanism may extend all the way across from one door to another. The rigid support structure 110 along with seats 130 and/or 140 placed or attached to their associated support structures 110 may be moved to enable a passenger to move to a row of seating behind the seats that are being moved. The sliding mechanism 112 is illustrated as rails in FIGS. 2A and 2B, but a variety of mechanisms may be used to slide or move the seats 130 and/or 140 as would be understood by a person of ordinary skill in the art. Those other mechanisms may be used without departing from the scope of the invention. FIGS. 3A and 3B illustrate the sliding mechanism 112 in a configuration where the seat 130 and the rigid support structure 110A are moved towards the center of the vehicle.

FIG. 2C illustrates the rigid support structure 110 in accordance with another embodiment of the invention. In this embodiment, the rigid support structure extends the entire width of a vehicle. It includes rigid support members 202A, 202B, 202C, and/or 202D. Other support members may be used without departing from the scope of the invention. The rigid support structure 110 may also include closure elements 204A and/or optionally 204B and/or 204C that may extend between the various support members 202A, 202B, 202C, and/or 202D. The rigid support structure 110 may also include an access port 111. The access port 111 may be a door that opens from a hinge, slides like a shutter or a garage, or may open and close via any mechanism that would be used or known by a person of ordinary skill in the art without departing from the scope of the invention. In one embodiment, the rigid support structure 110 may also include accommodation 118 to accommodate transmission components that may run vertically in a car. The accommodation 118 may not be needed in electric cars that do not have a transmission hump running through the floorboards.

In one embodiment, the rigid support structure 110 may be bolted on to the frame of the vehicle chassis. This may enable a floating structure, which is within the scope of the present invention.

In one embodiment, the rigid support structure 110 is designed to be securely fastened at the bottom to the frame of the vehicle using, for example, bolts or by being welded to the vehicle frame. In one embodiment, the rails 112 that support the rigid support structure 110 may be bolted onto the floors via coupling systems 250A, 250B, 250C and/or 250D as illustrated in FIGS. 2A and 2B. Other mechanisms for securing the rigid support structure 110 to the vehicle, which are known to persons of ordinary skill in the art, may be used without departing from the scope of the invention.

In one embodiment, the rigid frame structure 110 supports a passenger seat assembly that would be fastened to the top of the rigid frame structure 110 using, for example, bolts or by being welded. The rigid frame structure 110 and associated seat assembly would be designed to pass crash-worthiness tests when properly attached to the frame of the vehicle and when passengers are securely fastened using approved seat belts. The height of the rigid frame structure 110 would be predetermined to provide an appropriate elevated seat, based on different parameters such as vehicle model specific dimensions, number of rear seat rows, height of the vehicle roof, etc.

FIG. 3A illustrates how the first rear seat row 130 could be fabricated with support structure 110A such that, for example, a side door 111 can be opened to access stowage space enclosed within the support structure under this row of elevated rear seats 130. This access door 111 could be configured as a hinged door with a latch or could be configured with a mechanism to permit it to be selectively attached/detached from the access opening. In other exemplary embodiments, the stowage compartment is left open without having a side door 111. Depending upon configuration details of the vehicle, the stowage compartment might be accessible from the front, sides, and/or rear faces of the stowage compartment.

FIG. 3B illustrates additional stowage space 305 that is created by the support structure 110B (not shown) under seat 140. The additional stowage space 305 may be accessible from the back of the vehicle such as via a trunk or a hatch door access as illustrated in FIG. 3B.

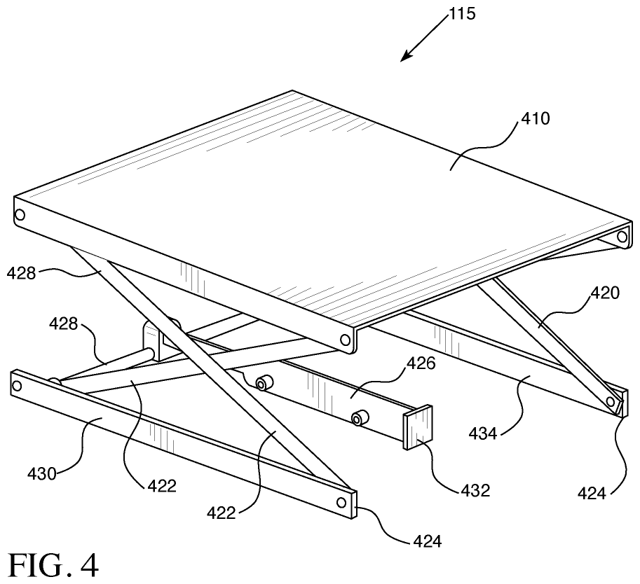

FIG. 4 illustrates another component of exemplary embodiments of the invention in which one or more adjustable footrests 115A and/or 115B is provided to passengers to increase comfort and improve ergonomics while being seated in an elevated seat 130 and/or 140. In some embodiments each passenger position is provided with a adjustable footrest(s) 115A and/or 115B, thereby providing each passenger with an adjustable footrest. Only one adjustable footrest(s) 115A and/or 115B115 is exemplarily shown in FIG. 4, but each rear passenger in each rear row of seats could be provided with their respective foot rest. These adjustable footrests 115, when in their lowermost position, permit each rear row passenger to climb into their elevated seat 130 and/or 140. Once situated in the seat, the passenger can then adjust the height of the footrest 115 to their personal preference.

FIG. 4 illustrates features of an exemplary adjustable footrest platform 115. The adjustable footrest platform 115 is represented in FIGS. 1A and 1B as 115A and/or 115B exemplarily and is also referred to as an adjustable footrest herein. As would be understood by a person of ordinary skill in the art, a footrest 115 may be provided in front of each rear passenger seat of a vehicle. The adjustable footrest 115 is used to create a more comfortable and ergonomic seating position for a rear passenger seat occupant. As shown in FIG. 4, the adjustable footrest(s) 115A and/or 115B comprises an adjustable platform 410 supported by two scissor support members 420, 422, each scissor support member 420, 422 being pivotally attached at the rear end 424 to floor supports 424. The front end 428 of actuator 426 is attached to the front end 430 of the scissor support members 420, 422, and the rear end 432 of the actuator is configured to brace solidly against the bottom structure of elevated seat (not shown in FIG. 4A). As shown in FIG. 4B and FIG. 4C, as the actuator 426 extends and retracts, the front edges of the scissor support members 420, 422 slide along the bottom support brackets 432, 434, to raise and lower the platform 410, as exemplarily shown in actuation steps shown in FIG. 4.

In some exemplary embodiments, the actuator 426 is spring-loaded so that the platform 410 lowers when the passenger steps on it and then raises as the passenger's body weight is removed as the passenger sits on the seat. Other mechanisms to raise the platform, which are known to a person of ordinary skill in the art, are hereby incorporated and considered within the scope of the invention.

In other exemplary embodiments, each passenger has their respective footrest 115A and/or 115B and others, and the actuator is controlled by an electric motor drive, and each passenger would have access to their own footrest actuator control switch that could be mounted in any of various possible locations relative to that passenger seat location. A preferred location for the actuator control switch might be directly under the individual passenger seat or on the back of a seat back directly in front of the user, in a location easily accessible by the passenger when seated.

Although the exemplary embodiment includes adjustable footrests 115, it should be clear that other platform configurations are possible. For example, adjustable footrest platforms could be rigidly attached to either the front face of the stowage compartment serving to support the elevated seat or to the rear face of the seats in front of the elevated row of seats. In another example, the adjustable footrest platform 115 may be rigidly attached to the back face of a chairs/seats that are directly in front of the elevated seats 130 and/or 140.

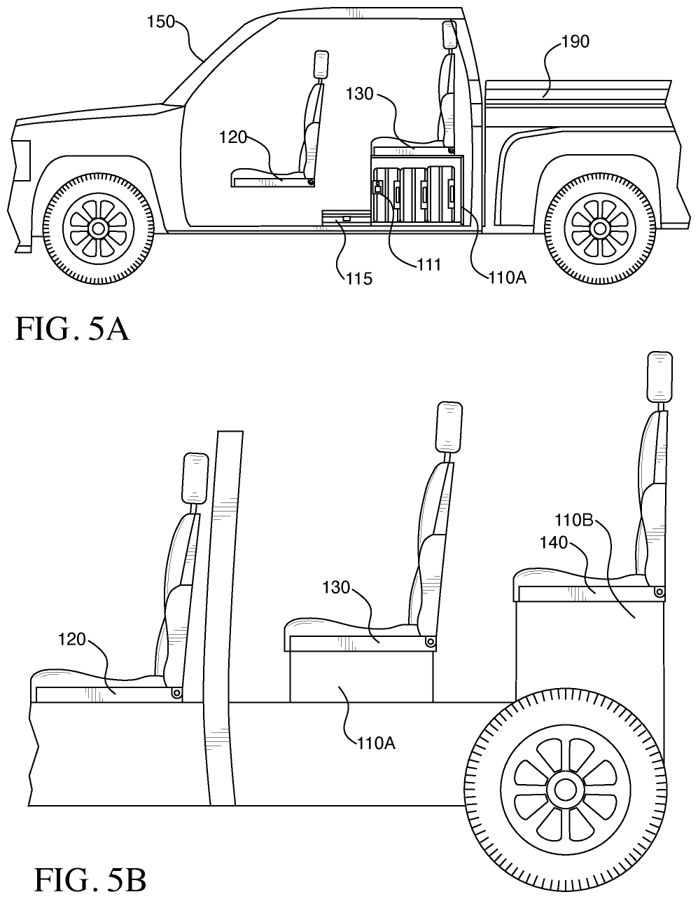

FIG. 5A and FIG. 5B show exemplary dimensions involved with two different vehicles, as might be dependent upon the number of rear passenger seat rows and specifics of different vehicle models. Thus, as shown exemplarily in FIG. 5A, the difference in elevation for a single row of rear passenger seat might be slightly larger than the difference in elevations for rear passenger seats when two rows of rear passenger seats are installed in a vehicle, as exemplarily shown in FIG. 5B. However, such dimensions are not intended as limiting the invention, since it should be clear that different vehicles would have potentially different desirable differences in elevations for the rear passenger seats. Exemplarily, as shown in FIG. 5A, the rear seats 130 are elevated 8.66 inches above the height of the front seats 120. In FIG. 5B, the rear seats 130 are elevated 7.874 inches above the height of the front seats 120, and the second rear seats 140 are elevated 15.748 inches above the height of the front seats 120. These distances are relative. As discussed above the rear seats 130 and 140 may be elevated 5 to 60 centimeters above the floorboards of the vehicle without departing from the scope of the invention.

Also from the examples illustrated in the various figures, it should be clear that entire vehicles could be designed to support the concepts of the present invention. However, it should also be clear that the present invention is not limited to entire vehicles that are designed and manufactured with the elevated rear seat features. In this aspect of the invention, retrofit kits would be available that permit existing conventional vehicles to replace their rear passenger seat rows with one or more aspects of the invention.

For example, in some retrofit scenarios, the retrofit kit might contain only elevated rear seat structures that are to be bolted to the vehicle frame when the existing seat structures are removed for replacement. Some retrofit kits could also include side windows and stowage compartment door components.

It should also be clear that any number of variations could be used to implement the concepts of the present invention. For example, rather than having the elevated seats provided as an integrated structure with multiple seat positions (for example, three seats), the elevated seats could be implemented using separate seat structures for each seat in the row of rear seats, and each of these individual seat structures could have different designs, including, for example, different elevation heights, or the capability to rotate the seat, recline the seat, or slide the seat forward/aft, etc.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and Bis false (or not present), A is false (or not present) and Bis true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for creating an interactive message through the disclosed principles herein. Thus, while particular embodiments and applications have been illustrated and described, it is to be understood that the disclosed embodiments are not limited to the precise construction and components disclosed herein. Various apparent modifications, changes and variations may be made in the arrangement, operation and details of the method and apparatus disclosed herein without departing from the spirit and scope defined in the appended claims.

1-16. (canceled)

17. A support structure for an elevated seat row for a vehicle, the support structure comprising a rigid frame configured with provisions on a bottom side to attach the support structure to a floor frame of a vehicle and provisions on a top side to attach a row of passenger seats, wherein a height of the rigid frame is predetermined to provide an elevated rear passenger seat that is elevated relative to a passenger seat located in front of a row of rear passengers, the elevated rear passenger seat thereby providing a rear passenger a forward view through a front windshield of the vehicle that is elevated relative to a passenger sitting in front of the rear passenger.

18. The support structure of claim 17, as configured to serve as a stowage compartment underlying the elevated seat row.

19. The support structure of claim 17, as comprising a kit of parts for a retrofit installation of an elevated rear seat row.

20. The support structure of claim 19, wherein the kit of parts further comprises a row of passenger seats to mount on top of the support structure.

21. The support structure of claim 17, wherein the height of the rigid support structure is between 5 and 60 centimeters (cm) higher for a second row of elevated seat structure relative to the height for a first row of elevated seat structure.

22. The support structure of claim 17, wherein a space between the support structure and a passenger seat assembly forms a stowage compartment beneath the passenger seat assembly.

23. The support structure of claim 22, wherein the stowage compartment is configured with access openings in at least one of a front, a rear, and left and right sides of the stowage compartment.

24. The support structure of claim 22, wherein the stowage compartment is configured with an access opening on each of left and right sides of the stowage compartment.

25. The support structure of claim 24, wherein each of the access openings is configured with an associated access door that can selectively cover the access opening.

26. The support structure of claim 17, wherein the height of the rigid support structure is between 5 and 60 centimeters (cm) higher for a third row of elevated seat structure relative to the height for a second row of elevated seat structure.

27. The support structure of claim 17, further comprising a footrest platform for each passenger location associated with the support structure.

28. The support structure of claim 27, wherein the footrest platform comprises a mobile footrest platform.
